(19) United States
(12) Patent Application Publication
(10) Pub. No.: US 2007/0243284 A1
(43) Pub. Date: Oct. 18, 2007

(54) Device for Expansion Injection Moulding

(76) Inventor: Georg STEINBICHLER, Boder (AT)

Correspondence Address: NOTARO AND MICHALOS, 100 DUTCH HILL ROAD, SUITE 110, ORANGEBURG, NY, 10962-2100, US

(21) Appl. No.: 11/695,165

(22) Filed: Apr. 2, 2007

(30) Foreign Application Priority Data
Apr. 12, 2006 (AT) A 634/2006

(51) Int. Cl. B29C 45/17

(52) U.S. Cl. 425/561; 425/557

(57) ABSTRACT

A device for expansion injection moulding, by which a polymer melt placed under pressure by a main pressure source can be injected from a storage chamber (4) into a mould cavity (3) by expansion of the polymer melt stored under pressure, the injection is optionally assisted by elastic deformation of the wall (8) of the storage chamber (4) and/or the wall (7) of a runner 6 leading to the storage chamber (4), the storage chamber (4) having an exit (5) which can be shut off, wherein the storage chamber (4) is arranged in a mould (1) which forms the mould cavity (3) and an additional pressure accumulator and/or an additional pressure source is (are) provided which is (are) capable of exerting additional pressure on the polymer melt during injection of the polymer melt into the mould cavity (3), in order to fill—preferably completely—the mould cavity (3).

### FIELD AND BACKGROUND OF THE INVENTION

The present invention relates to a device for expansion injection moulding, by means of which a polymer melt placed under pressure by a main pressure source can be injected from a storage chamber having an exit which can be shut off into a mould cavity by expansion of the polymer melt stored under pressure, optionally assisted by elastic deformation of the wall of the storage chamber and/or the wall of a runner leading to the storage chamber.

The basic concept of the expansion injection moulding technique is to provide the energy for overcoming the filling resistance during filling of cavities by compressing the melt. The compressibility of the polymer melt is utilized here. Due to the high pressures required, in the range of between 1,000 bar and 3,000 bar, an elastic deformation of the wall of the storage chamber and/or the wall of a runner leading to the storage chamber necessarily also occurs to a certain extent. After the exit which can be shut off has opened, the wall thereby assists in injection of the polymer melt into the mould cavity, although usually only to a very small extent. In order to be able to store sufficient pressure or energy in the polymer, in addition to a correspondingly high compressing pressure, provision must be made for the volume of the storage chamber to be several times the mould cavity volume. This has the disadvantage that only a fraction of the polymer melt placed under pressure in the storage chamber before an injection operation is actually injected into the mould cavity, and the remainder remains in the storage chamber for several cycles. This as a rule leads to a more or less severe thermal and pressure-related damage to the polymer melt even before it is injected into the mould cavity. In this context, it is to be remembered that after opening of the closure mechanism, not only must the cavity, that is to say the mould cavity, be filled volumetrically with the expanding polymer melt, but a residual pressure must also still be present after pressure compensation has taken place, this assuming a follow-up pressure function for oscillatory compensation of the cooling melt

### SUMMARY OF THE INVENTION

It is an object of the invention to shorten the duration of dwell of the polymer melt in the storage chamber and to be able to inject the polymer melt with the lowest possible pressures, so that damage to the polymer melt before injection is reduced or completely suppressed.

This is achieved according to the invention in that the storage chamber is arranged in a mould which forms the mould cavity, and an additional pressure accumulator and/or an additional pressure source is (are) provided which is (are) capable of exerting additional pressure on the polymer melt during injection of the polymer melt into the mould cavity, in order to fill—preferably completely—the mould cavity.

By this measure according to the invention, the process can be carried out with substantially smaller volumes of polymer melt in the storage chamber. It is no longer necessary, as in the prior art, for substantially the total energy needed for complete filling of the mould cavity to be stored in the polymer melt. Rather, by means of the additional pressure accumulator or the additional pressure source, additional pressure can be exerted on the polymer melt passively (pressure accumulator) or actively (pressure source) for injection the polymer melt. By arrangement of the storage chamber in the mould, the flow resistances between the storage chamber and the mould cavity are reduced to a minimum, so that work can be also carried out with lower pressures.

It is thereby advantageous when the additional pressure accumulator and/or the additional pressure source is (are) arranged in the mould.

The pressure accumulators according to the invention are as a rule constructed and connected to the storage chamber such that they can preferably be loaded exclusively by the main pressure source via the polymer melt. In this context, the injection plungers or screws known in the prior art which, by an appropriate advance in the plasticizing cylinder, convey the polymer melt from this via a hot runner system which is known per se into the storage chamber and place it under pressure there, function as main pressure sources. In the case of the passive pressure accumulators, not only the polymer melt but also the additional pressure accumulator is thus loaded with energy or pressure by the plasticizing screw or the injection plunger. Alternatively or in addition to the passive pressure accumulator, however, an additional pressure source can also be provided. This is as a rule constructed such that the polymer melt can be charged with pressure, in addition to the main pressure source, in the storage chamber and/or in the runner. The additional pressure source is thus an active additional element.

Additional pressure accumulators and also additional pressure sources can be arranged or constructed in the storage chamber and/or in a runner leading to the storage chamber and/or instead of at least a part of the wall of the storage chamber and/or instead of at least a part of the wall of the runner leading to the storage chamber. They can comprise elastically deformable solid bodies or fluid stores or combinations thereof. In the latter combination, the additional pressure is exerted on the polymer both by the elastic deformation of the solid body and by the elastic deformation of the fluid store. Mechanical spring systems, e.g. in the form of spring-loaded plungers or spring-loaded sleeves or sleeves which are springy in themselves, can be provided e.g. as additional pressure accumulators. In the development as hydromechanical or pneumatic-mechanical spring systems, this can be e.g. fluid-loaded plungers or fluid-loaded extensible sleeves. In the case of pure fluid stores or fluid sources or the use thereof in the combination mentioned, these can be filled with gas or liquid. However, the additional pressure source can also comprise a hydraulically or pneumatically or electrically actuatable plunger or a hydraulically or pneumatically deformable membrane or wall.

In order to ensure that on expansion of the polymer melt this acts in the direction of the mould cavity and not in the opposite direction of the runners leading into the storage chamber, it may be sufficient to make provision for the flow resistance in the connecting region of the storage chamber and mould cavity to be considerably lower than that in the runner (system) lying upstream of the storage chamber. In order alternatively or additionally to ensure, however, that as far as possible the total energy is employed for filling the mould cavity during expansion of the polymer melt, a further shut-off element can also be provided at the entry of the storage chamber or in a runner leading to the storage chamber, preferably at the entry thereof into the mould.

### BRIEF DESCRIPTION OF THE DRAWINGS

Further details and features of the present invention emerge from the following description of figures. There are shown in:

FIGS. 1 and 2 a first embodiment according to the invention,

FIG. 3 a second embodiment according to the invention,

FIGS. 4 and 5 a third embodiment according to the invention and

FIG. 6 a fourth embodiment according to the invention.

### DESCRIPTION OF THE PREFERRED EMBODIMENT

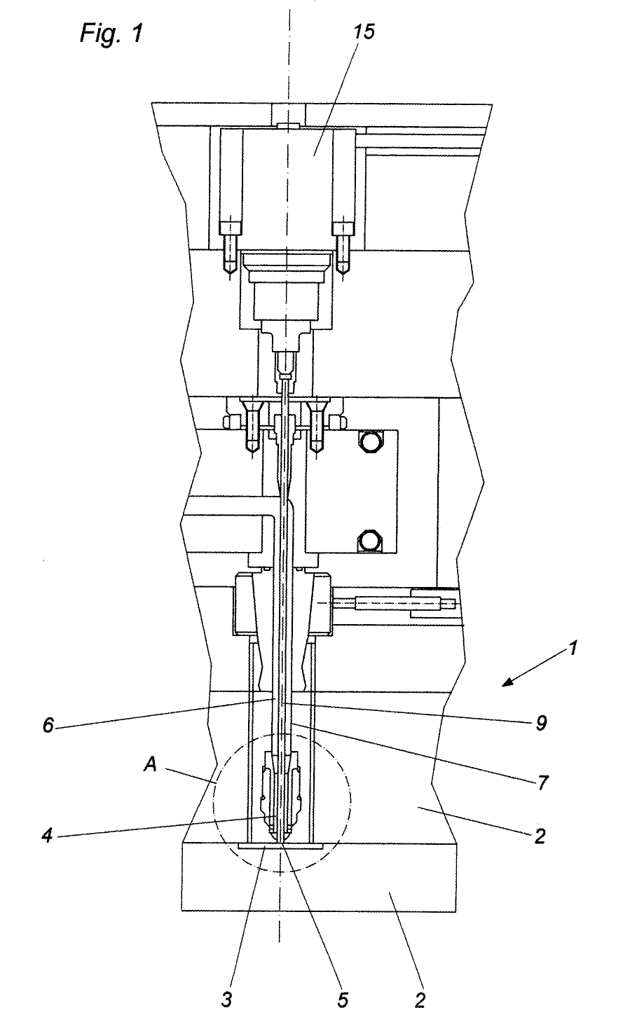

FIG. 1 shows a section of a platen with a mould 1 constructed according to the invention fixed thereon. The polymer melt plasticized in a plasticizing cylinder, which is known in the prior art but not shown here, of an injection moulding device, for example by a screw, is forced via a shut-off device, which is likewise known in the prior art and is arranged at the exit of the plasticizing cylinder, into a hot runner distribution system, which is likewise known. Due to its advance in the plasticizing cylinder, the plasticizing screw serves here as the main pressure source, which conveys the plasticized material under pressure into the hot runner system and therefore also into the runner 6 shown here. The runner 6 opens into the storage chamber 4, which is arranged as close as possible to the mould cavity 3 directly in one of the two mould halves 2 of the injection mould 1. The shut-off needle 9 serves as a shut-off device for the exit 5, on the mould cavity side, of the storage chamber 4. A drive 15 which is known per se is provided for actuation thereof. This can be constructed e.g. as a hydraulic or pneumatic cylinder or electrically, e.g. as a stepping motor. The flow front speed for filling the mould cavity 3 can be influenced by a control or regulation of the opening movement of the shut-off needle 9 and the gap resulting therefrom as a function of time in the exit 5 and the associated loss of pressure in the flowing/expanding polymer melt. Electrical stepping motors are preferably suitable for such an adjusting movement of the shut-off needle 9. For example, there can be provision for it to have a control device which is intended to open and/or to close in a controlled and/or regulated manner the exit, which can be shut off, in the mould cavity as a function of a predeterminable volume/flow profile. In this context, the volume/flow profile is predetermined, for example, as a function of the particular development of the mould cavity. As a rule, this leads to a filling of the mould cavity which is delayed in a controlled manner. In the case of a control, courses of the degree of opening of the exit 5 which can be predetermined in a fixed manner can be realized here. These can include sequences of complete, partial and/or intermittent opening of the exit 5. In the development in the form of a closed-loop control system, at least a measured actual value, for example of the current pressure in the mould cavity 3 and/or in the storage chamber, is additionally also used to determine the volume/flow profile or course.

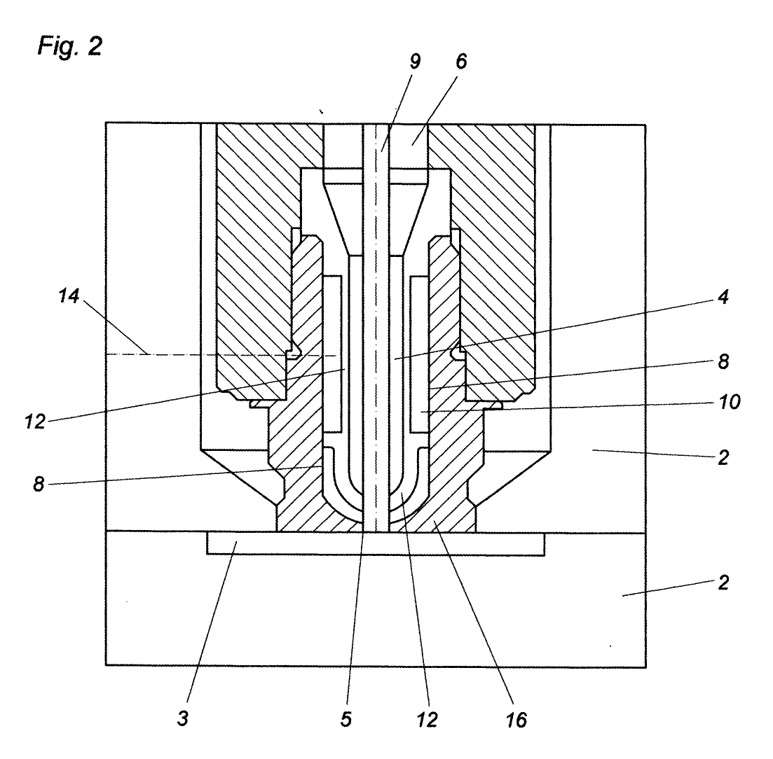

In conventional expansion injection moulding, as described above, it is necessary to provide very large volumes in the storage chamber 4, so that sufficient pressure or energy can be stored. In order to avoid the disadvantages from this already described, in the embodiment according to the invention shown in FIG. 1 an additional pressure accumulator is arranged in the storage chamber 4. This can be seen particularly clearly in FIG. 2, which shows the essential parts of section A from FIG. 1. In this embodiment, the additional pressure accumulator is constructed in the form of an elastically sprung sleeve 12. The latter is prepressurized when the polymer melt is forced into the storage chamber 4 and thereby stores some of the pressure required for later filling of the mould cavity 3. As a result, the total energy or the total pressure necessary for filling the mould cavity 3 no longer has to be stored in the system by compression of the polymer melt. The total internal volume of the storage chamber 4 surrounded by the wall 8 can also be of considerably smaller dimensions as a result, so that the polymer melt is also injected very rapidly into the mould cavity 3 as soon as it enters into the storage chamber 4. Damage to the polymer melt even before injection into the mould cavity 3 by compression and expansion several times due to long dwell times of this in the storage chamber 4 is thereby avoided.

The compression volume required in the concrete case in the storage chamber 4 can be calculated or estimated starting from the volume of the mould cavity 3 to be filled, the filling resistance thereof (flow path/wall thickness ratio), the viscosity of the polymer melt used and the processing conditions as well as the desired residual pressure after expansion has taken place.

The extensible sleeve 12, which is springy in itself, can initially be constructed on the one hand in a passive form in the form of an additional pressure accumulator. That is to say, it is prepressurized by the main pressure source via the polymer melt. In a simple embodiment, the pressure accumulator can be based purely on the elastic properties of the solid body of the sleeve 12 per se. However, the sleeve 12 can also be constructed as a hydromechanical or pneumatic-mechanical spring system, wherein the fluid inclusions 10 likewise store pressure. These can be filled both with gas and with suitable liquids and can serve as an additional pressure accumulator in interaction with the elastic properties of the solid body of the sleeve.

In order to construct this form, which is passive per se, of an additional pressure accumulator as an active additional pressure source in the context of the invention, fluid can be forced from the outside from an additional source, which is not shown here, into the fluid store 10 via a line 14, indicated here as a broken line. In this case of an active pressure source, prepressurizing of the extensible sleeve is thus then no longer caused primarily via the main pressure source and the polymer melt, but via the fluid in the feed line 14. Fluid pumps, hydraulic or pneumatic cylinders or the like which are known per se can be connected to the feed line 14 as an additional source. However, in order for it to be constructed as an active additional pressurizing source, the extensible sleeve 12 can also be prepressurized or moved by an electrical or electromechanical or magnetic or piezoelectric actuator. The dimensions of the extensible sleeve 12 are in principle such that it does not break when exposed to pressure by the melt compression pressure or by the additional pressure via the fluid store 10, but renders possible a maximum elastic deformation for storage of energy in addition to the compressed polymer melt. The advantage of this variant is, above all, that no moving elements, e.g. plungers, actuation of which is usually friction-dependent, are necessary.

The wall 8 of the storage chamber 4 can be constructed as a screw-in part 16, as shown here.

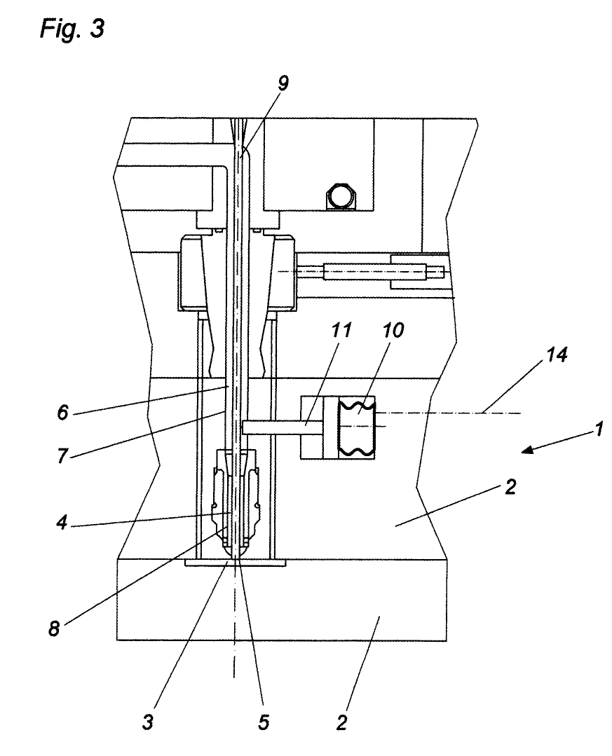

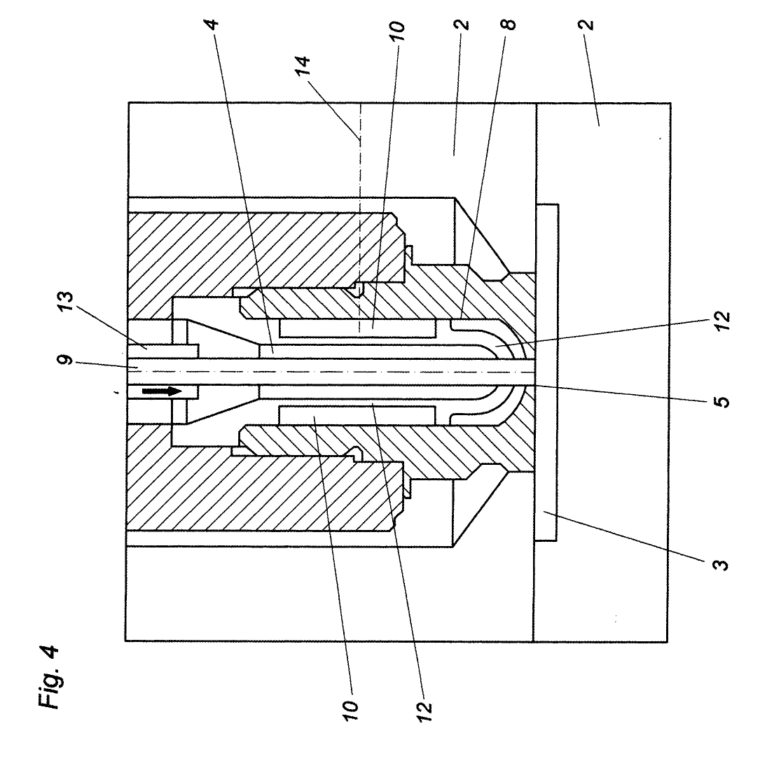

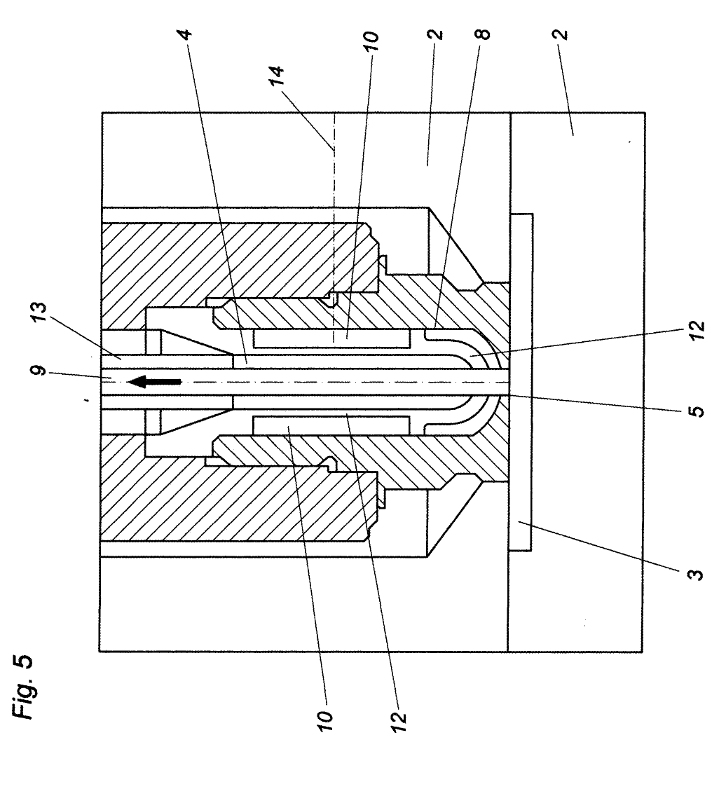

FIG. 3 shows another embodiment according to the invention of an additional pressure accumulator. This has a plunger 11 extending into the runner 6. The plunger 11 is guided in a cylinder and acts on a fluid pressure accumulator 10, which can likewise be filled with elastically deformable gas or a corresponding liquid, such as e.g. thermal oil. In deviation from the embodiment shown here, the plunger 11 can also open directly into the storage chamber 4. This is to be provided in particular if a further shut-off element 13 is provided in accordance with FIGS. 4 and 5 explained below. If the feed line 14, shown as a broken line, for the fluid store 10 is omitted, an additional passive pressure accumulator is again present, which is charged with pressure via the compressed melt in the runner 6 (or in the storage chamber 4). In this embodiment, the fluid store 10 can also be replaced by an elastically deformable solid body, such as helical springs, elastomer packages or the like. However, it is also possible to construct the plunger 11 as an active element and therefore the plunger/cylinder arrangement as an additional pressure source. In the case of a fluid store 10, this can in turn be realized by a feed line 14 with an additional pressure source, which is not shown here, arranged behind. Alternatively, however, it is also possible to provide electrical pulse motors or magnetizing coils or piezoelectric actuators or the like which can prepressurize or displace the plunger 11 as an additional pressure source.

In the embodiments shown so far, the storage chamber is open in the direction of the runners 6 and can be shut off at its exit 5 via one shut-off needle 9 only in the direction of the mould cavity 3. This functions as long as the flow resistance in the runner 6 is significantly greater than en route from the storage chamber 4 into the mould cavity.

Alternatively or in addition, however, a further shut-off element 13 can also be provided at the entry of the storage chamber 4 (as shown in FIGS. 4 and 5) or in the runner 6 leading to the storage chamber 4, e.g. at the entry thereof into the mould. In the embodiment shown, the further shut-off element 13 is constructed in the form of a sleeve which can be displaced along the shut-off needle 9 via its own drive, which is not shown here, and which is capable of shutting off the storage chamber 4 from the runner 6. FIG. 4 shows the position in which the polymer melt can be introduced into the storage chamber 4. FIG. 5 shows the shut-off state, such as exists during injection of the polymer melt into the mould cavity 3. This further shut-off element 13 ensures practically 100% release of pressure between the storage chamber 4 and runner 6 in the closed stated according to FIG. 5. As a result, on the one hand it is ensured in an optimum manner that after opening of the shut-off needle 9, the expansion of the polymer melt, assisted by the release of pressure of the additional pressure accumulator or by the additional pressure source, is available completely for filling the mould cavity 3. Furthermore, this shut-off device has the advantage that the polymer melt present in the runner 6 does not undergo a release of pressure and therefore also does not expand, but remains in the compressed state, as a result of which compression and expansion of the melt several times before injection into the mould cavity 3 is further suppressed. Moreover, expansion of the melt from a compression chamber (storage chamber) thereby takes place therefrom with a defined volume, whereby the prerequisite for highly precise filling of the mould cavity 3 is further improved. A further shut-off device 13 on the runner side furthermore also has the advantage, however, as does also a corresponding shut-off device, which is not shown here, of the plasticizing cylinder, that after closing of the particular shut-off device, the screw in the plasticizing cylinder can already start with the plasticizing of fresh polymer melt again during the actual injection operation. As a result, the cycle times between two injection operations are reduced.

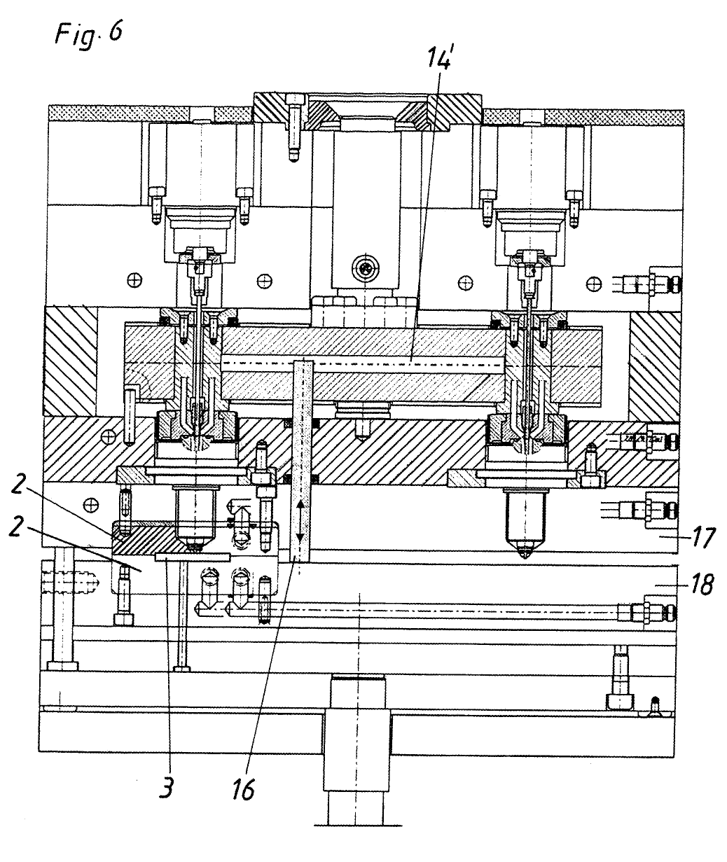

FIG. 6 shows a diagram of a variant according to the invention of how the prepressurizing of an additional pressure source can be actuated by the closing force. On closing of the mould 1 and on application of the closing force, the mould halves 2, as is known per se, are pressed against one another by means of the platens 17 and 18. In this context, in this embodiment the additional plunger 16 which can be mounted displaceable in the platen 17 is simultaneously pressed by the other platen 18 into the supply line 14′ filled with hydraulic fluid, as a result of which the hydraulic fluid is displaced. The supply line 14′ can in turn be connected to the supply lines 14 according to FIGS. 3 and 4, as a result of which the corresponding additional pressure sources are prepressurized via the displacement or closing of the platens 17, 18.

A method for operating the device according to the invention can vary in construction, depending on the embodiment. In the case of passive additional pressure accumulators at any rate, provision is made first on the one hand for polymer melt to be forced by the main pressure source, that is to say as a rule the screw in the plasticizing cylinder, via the runner 6 into the storage chamber 4. In this context, both pressure and energy are stored in the melt itself by compression, and also the additional pressure accumulator is prepressurized. As soon as the previously determined prepressurizing pressure is reached, the further shut-off device 13 optionally present and also a shut-off device optionally present on the plasticizing cylinder are closed. From this point in time, the screw can already start with preparation for polymer melt for the next injection operation. In the steps mentioned so far, the shut-off device of the exit 5 between the storage chamber 4 and mould cavity 3 is closed. This is opened only when the prepressurizing pressure is reached and the further shut-off device 13 optionally present is closed, so that the mould cavity 3 is then filled by expansion of the polymer melt and release in the pressure of the additional pressure accumulator. The dimensions of the prepressurizing pressure here are as a rule such that the previously determined follow-up pressure is also still available after filling of the mould cavity 3.

If the passive additional pressure accumulator is replaced by an active additional pressure source, this can implement the additional pressure build-up either during the pressure build-up in the melt or only after closing of the further shut-off device 13. The other method steps are the same as in the use of additional pressure accumulators. The active additional pressure sources or pressure accumulators can moreover also be used as an actuator for providing a follow-up pressure which is to be maintained after the injection.

The invention in particular is not limited to devices having only one mould cavity 3 in the mould 1. Rather, provision can also be made for several mould cavities to be arranged in the mould, wherein several storage chambers are assigned to these and the shut-off devices, preferably constructed as needle shut-off devices, of the storage chambers have a common actuating device. Several pressure accumulators or additional pressure sources, e.g. in the form of plungers 11, can correspondingly also additionally be provided in the mould 1. The most diverse forms of elastically deformable hot runner or machine components can in principle serve as additional energy accumulators. Parts of the wall 8 of the storage chamber 4 or parts of the wall 7 of the runner 6 can thus also be replaced by correspondingly elastically deformable additional pressure accumulators.

1. A device for expansion injection moulding, by means of which a polymer melt placed under pressure by a main pressure source can be injected from a storage chamber into a mould cavity by expansion of said polymer melt stored under pressure, said injection is optionally assisted by elastic deformation of the wall of said storage chamber or the wall of a runner leading to said storage chamber or said wall of said storage chamber and said wall of said runner leading to said storage chamber, said storage chamber having an exit which can be shut off, wherein said storage chamber is arranged in a mould which forms the mould cavity, and at least one member of a group consisting of an additional pressure accumulator and an additional pressure source is provided which is capable of exerting additional pressure on said polymer melt during said injection of said polymer melt into said mould cavity, in order to partly or completely fill said mould cavity.

2. The device according to claim 1, wherein at least one member of the group consisting of said additional pressure accumulator and said additional pressure source is arranged in said mould.

3. The device according to claim 1, wherein said additional pressure accumulator is constructed and is connected to said storage chamber such that it can be loaded or prepressurized partly or exclusively by said main pressure source via said polymer melt.

4. The device according to claim 1, wherein said additional pressure source is constructed such that a polymer in said storage chamber or in said runner or in said storage chamber and in said runner can be charged with pressure by said additional pressure source additionally to said main pressure source.

5. The device according to claim 1, wherein at least one member of the group consisting of said additional pressure accumulator and said additionally pressure source comprises an elastically deformable solid body which is provided in at least one region chosen from a group consisting of said storage chamber and said runner leading to said storage chamber.

6. The device according to claim 5, wherein said elastically deformable solid body is provided instead of at least a part of a wall chosen from a group consisting of said wall of the storage chamber and said wall of said runner leading to said storage chamber.

7. The device according to claim 5, wherein at least one member from the group consisting of said additional pressure accumulator and said additional pressure source is constructed such that said additional pressure can be exerted on said polymer melt solely on the basis of the elastic deformation of said solid body.

8. The device according to claim 5, wherein at least one member from the group consisting of said additional pressure accumulator and said additional pressure source is constructed such that, in the combination of elastic deformation of said solid body with an elastic deformation of a fluid store, said additional pressure can be exerted on said polymer melt.

9. The device according to claim 1, wherein at least one member from the group consisting of said additional pressure accumulator and said additional pressure source comprises a mechanical spring system or a spring-loaded plunger or a spring-loaded sleeve ora sleeve which is springy initself.

10. The device according to claim 1, wherein at least one member from the group consisting of said additional pressure accumulator and said additional pressure source comprises a hydromechanical or pneumatic-mechanical spring system or a fluid-loaded plunger or a fluid-loaded extensible sleeve.

11. The device according to claim 1, wherein at least one member from the group consisting of said additional pressure accumulator and said additional pressure source comprises a fluid store filled with gas or liquid.

12. The device according to claim 1, wherein said additional pressure source comprises a hydraulically or pneumatically or electrically or piezoelectrically actuatable plunger or a hydraulically or pneumatically deformable membrane or wall.

13. The device according to claim 1, wherein a further shut-off element is provided at the entry of said storage chamber or in said runner leading to said storage chamber.

14. The device according to claim 13, wherein the further shut-off element is arranged in said mould at the entry of said runner leading to said storage chamber.

15. The device according to claim 1, wherein the flow resistance in the connecting region of said storage chamber and said mould cavity is considerably lower than that in said runner lying upstream of said storage chamber.

16. The device according to claim 1, wherein the length of said runner leading to said storage chamber is at least ten times the distance of said storage chamber from the said mould cavity.

17. The device according to claim 1, wherein several mould cavities are arranged in said mould, wherein several storage chambers are assigned to these and the shut-off devices of said storage chambers have a common actuating device.

18. Device according to claim 17, wherein said shut-off devices of said storage chambers are constructed as needle shut-off devices.

19. Device according to claim 1, wherein said device comprises a control device which is intended to open or to close in a controlled or regulated manner said exit into said mould cavity as a function of a predeterminable volume/flow profile.
